(19) United States
(12) Patent Application Publication
(10) Pub. No.: US 2012/0069251 A1
(43) Pub. Date: Mar. 22, 2012

(54) DUAL PANEL MICRO REFLECTIVE LIQUID CRYSTAL PROJECTION DEVICE

(76) Inventors: SHIN-GWO SHIUE, Hu Kou Township (TW); David Tsai, Hu Kou Township (TW)

(21) Appl. No.: 12/886,579

(22) Filed: Sep. 21, 2010

(51) Int. Cl. G02F 1/13363

(52) U.S. Cl. 349/9

(57) ABSTRACT

A dual-panel micro reflective liquid crystal projection device is provided for improving brightness of projected image, including a set of two reflective liquid crystal panels respectively arranged at top side and right side of a polarizing beam splitter so that a light beam emitting from a light source located at bottom side of the beam splitter is received and split by the beam splitter into a horizontal polarization component and a vertical polarization component, which are then respectively reflected and modulated by the two reflective panels into vertically polarized light and horizontal polarized light for simultaneously transmitting identical image signals to a projection system arranged at left side of the beam splitter to thereby double the brightness of the image projected onto a screen.

### TECHNICAL FIELD OF THE INVENTION

The present invention generally relates to a dual panel micro reflective liquid crystal projection device, and more particularly to such a projection device that provides improved projection brightness of a micro projector.

### DESCRIPTION OF THE PRIOR ART

A conventional desktop projector provides visual sensation of large screen, but it is not readily portable due to its volume and weight and the need for supply of power.

The state-of-the-art micro projectors remove the constraints in relation to volume, weight, and the need for external power supply, allowing for easy portability and readily use for projection of image. However, the existing micro projectors have an inherent disadvantage in relation to insufficiency of projection brightness. This requires further improvement.

In view of the inherent disadvantage of insufficient projection brightness, the present invention, of which a more detailed description will be given with reference to an embodiment of a dual panel micro reflective liquid crystal projection device, aims to provide a modification to change the existing single panel based reflective liquid crystal projection system into a dual panel reflective liquid crystal projection without making any alteration to the conditions of operation of an existing light source and the conditions of existing light path, so that a horizontally polarized component of light that was heretofore wasted and not used is re-used to effectively double the projection brightness of a micro projector.

### SUMMARY OF THE INVENTION

Thus, an objective of the present invention is to provide a dual panel micro reflective liquid crystal projection device, which comprises a set of two reflective liquid crystal panels respectively arranged at top side and right side of a polarizing beam splitter so that a light beam emitting from a light source located at the bottom side of the beam splitter is split by the beam splitter into a horizontal polarization component and a vertical polarization component, which are then respectively reflected and modulated by the two reflective panels into vertically polarized light and horizontal polarized light, with a purpose to fully use all optic energy carrying by the original light beam and also for simultaneously transmitting identical image signals to a projection system arranged at the left side of the beam splitter to thereby double the brightness of image projection.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a light path of a conventional single-panel reflective liquid crystal projector.

FIG. 2 is a schematic view showing a light path of a dual-panel reflective liquid crystal projector according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

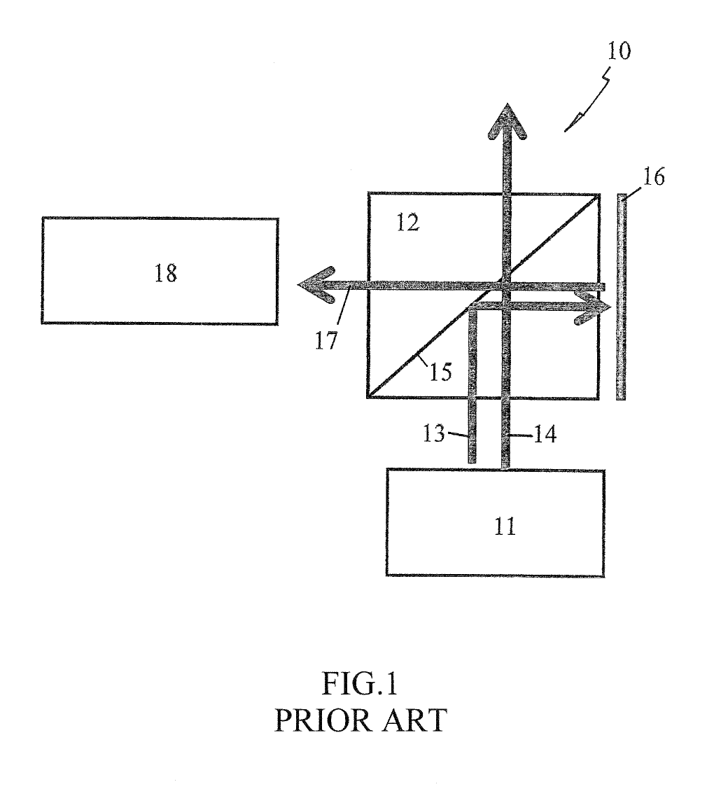

FIG. 1 of the attached drawings shows a schematic view of light path of a conventional single-panel reflective liquid crystal projector. The conventional micro projector, which is generally designated at 10, is disadvantageous in that the use rate of light is low. As can be observed from the drawing, a light system 11 emits a light beam composed of a vertical polarization component 13 and a horizontal polarization component 14, each taking 50% of the energy of the emitted light beam, into a polarizing beam splitter 12. When the vertical polarization component 13 travels into the polarizing beam splitter 12 and encounters an internal interface 15, the vertical polarization component 13 is re-directed toward a reflective liquid crystal panel 16, which is composed of a so call liquid crystal on silicon (LCoS) element, located at for example the right side of the polarizing beam splitter 12 and is subjected to modulation by the reflective liquid crystal panel 16 into horizontally polarized light 17 that is guided to a projection system 18. At the same time, the horizontal polarization component 14 from the same light system 11 directly transmits through the polarizing beam splitter 12 and absorbed by a structure located on the top side of the polarizing beam splitter 12. Consequently, the horizontal polarization component 14 is completely not used in the conventional micro projection system. In other words, the conventional micro projector 10 uses only 50% (namely the vertical polarization component) of the light supplied thereto.

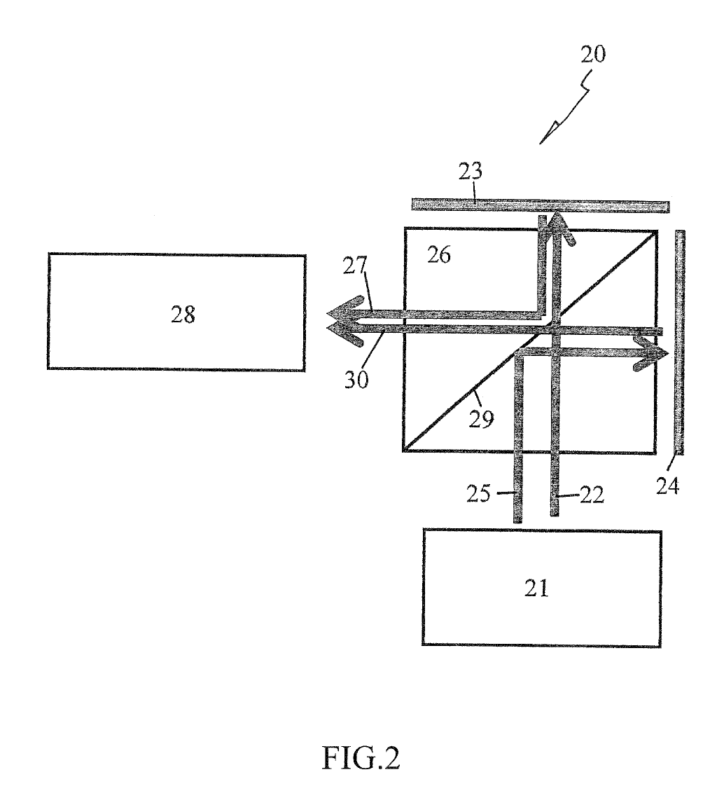

FIG. 2 shows a schematic view of light path of a dual-panel reflective liquid crystal projector according to the present invention. The micro projector of the present invention, generally designated at 20, is arranged to effectively use the horizontal polarization component, designated at 22, of a light beam from a light system 21 that is not used in the conventional micro projector described above through such an arrangement that a set of two reflective liquid crystal panels 23, 24 is provided and respectively set on the transmission path of the horizontal polarization component 22 and the reflection path of the vertical polarization component 25. With such an arrangement, the horizontal polarization component 22 of the light beam emitting from the light system 21 that was not used in the conventional micro projector is now allowed to transmit through a polarizing beam splitter 26 to reach the reflective liquid crystal panel 23 located at the top side of the polarizing beam splitter 26 by which modulation is applied to the horizontal polarization component 22 to become a vertically polarized light 27 that is re-directed toward an internal interface 29 of the polarizing beam splitter 26 to be reflected toward a projection system 28. At the same time, the vertical polarization component 25 of the light beam from the light system 21 is re-directed by the internal interface 29 of the polarizing beam splitter 26 to reach another reflective liquid crystal panel 24 located at for example the right side of the polarizing beam splitter 26 and is subjected to modulation by the reflective liquid crystal panel 24 to become a horizontally polarized light 30 that is re-directed to transmit through the polarizing beam splitter 26 to reach the projection system 28. Thus, the present invention provides an arrangement that allows for full use of the optic energy of a light beam projected therein for a given image and as a consequence, the performance of projection realized through the present invention is better than that of the single-panel liquid crystal projector by doubling the brightness of projected image.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dual-panel micro reflective liquid crystal projection device comprising a set of two reflective liquid crystal panels respectively arranged at top side and right side of a polarizing beam splitter so that a light beam emitting from a light source located at bottom side of the beam splitter is received and split by the beam splitter into a horizontal polarization component and a vertical polarization component, which are then respectively reflected and modulated by the two reflective panels into vertically polarized light and horizontal polarized light for simultaneously transmitting identical image signals to a projection system arranged at left side of the beam splitter.
